(19) United States
(12) Patent Application Publication
(10) Pub. No.: US 2023/0222334 A1
(43) Pub. Date: Jul. 13, 2023

(54) MODEL QUANTIZATION FOR SOFTWARE ENGINEERING TASKS

(71) Applicant: MICROSOFT TECHNOLOGY LICENSING, LLC., Redmond, WA (US)

(72) Inventors: COLIN BRUCE CLEMENT, SEATTLE, WA (US); SHAO KUN DENG, NEW YORK CITY, NY (US); NEELAKANTAN SUNDARESAN, BELLEVUE, WA (US); ALEXEY SVYATKOVSKIY, BELLEVUE, WA (US)

(21) Appl. No.: 17/572,459

(22) Filed: Jan. 10, 2022

(51) Int. Cl. G06N 3/08; G06N 3/04; G06K 9/62

(52) U.S. Cl. CPC G06N 3/08; G06N 3/04; G06K 9/6223; G06K 9/6228

(57) ABSTRACT

A deep learning model is quantized during its training to perform a target software engineering task. During training, a portion of the full-precision floating point weights is quantized into INT4 or INT 8 data types through scalar quantization or product quantization to make the model more resilient to quantization and to reduce the noise between the quantized and full-precision model outputs. In scalar quantization, each sub-block consists of a single weight that is mapped into a codeword of a codebook. In product quantization, an identity matrix and a codebook of centroids is used to map a quantized weight into its original value.

### BACKGROUND

Deep learning models are used often to solve a variety of problems. Deep learning models employ neural networks that are trained to learn to recognize patterns and make predictions from generalizing the learned patterns. One drawback of these models is the extensive amount of time and resources needed to train a deep learning model. A model may require a training dataset of real-world data consisting of several million data samples mined from various sources. The training itself may take days to weeks of computing time to train the model. Neural networks are trained iteratively, making multiple passes over the training dataset before converging to a minimum. The training is iterative and the entire training dataset is passed through the neural network in multiple iterations to find the hyperparameters (e.g., model architecture, vocabulary encoding procedures, training objective, data normalization) that meet a target objective.

Another drawback of these models is the large number of full-precision floating point parameters that are used and the millions of floating-point operations that are computed for a single inference. A model may contain hundreds of billions of parameters thereby requiring a large amount of storage. The computations also require an enormous amount of storage and computing power. The memory space and computational resources needed to utilize such models makes it impossible to deploy a model on resource-limited devices.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A deep learning model is trained through quantization with noise training to learn to perform a target software engineering task. During the quantized with noise training, a portion of the weights of a weight matrix are quantized into integer data types. By reducing the bit-width of a portion of the weights during training makes the model more resilient to quantization and reduces the noise or discrepancy between the quantized and full-precision model outputs. Upon completion of the training, all the weights of a weight matrix are post quantized into integer data types resulting in a smaller model size that consumes less resources to train and deploy in an inference system. The smaller-sized model is beneficial for computing environments with limited computing resources, such as mobile and resource-constrained devices.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF DRAWINGS

FIG. 1 is a schematic diagram illustrating an exemplary model quantization of a deep learning model trained for a software engineering task.

FIG. 2 is a schematic diagram illustrating the quantization with noise training of a deep learning model.

FIG. 3 is a schematic diagram illustrating an exemplary architecture of an encoder-decoder neural transformer model with attention.

FIG. 4A is a schematic diagram illustrating an exemplary architecture of an encoder-only neural transformer model with attention and FIG. 4B is a schematic diagram illustrating an exemplary architecture of a decoder-only neural transformer model with attention.

FIG. 5 is a flow diagram illustrating an exemplary method for quantizing a deep learning model.

FIG. 6 is a flow diagram illustrating an exemplary method of quantization with noise training.

FIG. 7 is a flow diagram illustrating an exemplary method of the deployment of the quantized deep learning model in an inference system.

FIG. 8 is a block diagram illustrating an exemplary operating environment.

### DETAILED DESCRIPTION

Overview

Various approaches are disclosed for quantizing a deep learning model during the training of the model to perform a software engineering task. A deep learning model learns to make predictions using computations that are based on weights. The weights are learnable parameters that are computed during the training of the model. Often the weights are represented as 32-bit or 16-bit floating point numbers which result in large-sized weight matrices used in the computations.

Quantization is a technique that reduces the number of bits representing a number by using a lower-precision data type. The weights used in the model may be quantized resulting in a smaller model size that consumes less resources to train and deploy in an inference system. The smaller-sized model is beneficial for computing environments with limited computing resources, such as mobile and resource-constrained devices.

In one aspect, the deep learning model is a neural transformer model with attention. A neural transformer model with attention includes an embedding layer having subtoken and positional embedding weight matrices and for each transformer block, a self-attention layer having attention weight matrices and biases and a feed-forward neural network layer having weights and biases. The biases are small values which do not need to be quantized.

In one aspect, the floating-point numbers (e.g., 32-bit or 16-bit floating point values) in these matrices are quantized into low precision fixed-point representations using INT8 or INT4 data types. An INT8 data type is an 8-bit integer and the INT4 data type is a 4-bit integer. The INT8 data type representation reduces data storage and bandwidth by a factor of 4 and results in a faster training time. The INT8 and INT4 data types are part of the Vector Neural Network Instruction set (VNNI) architecture.

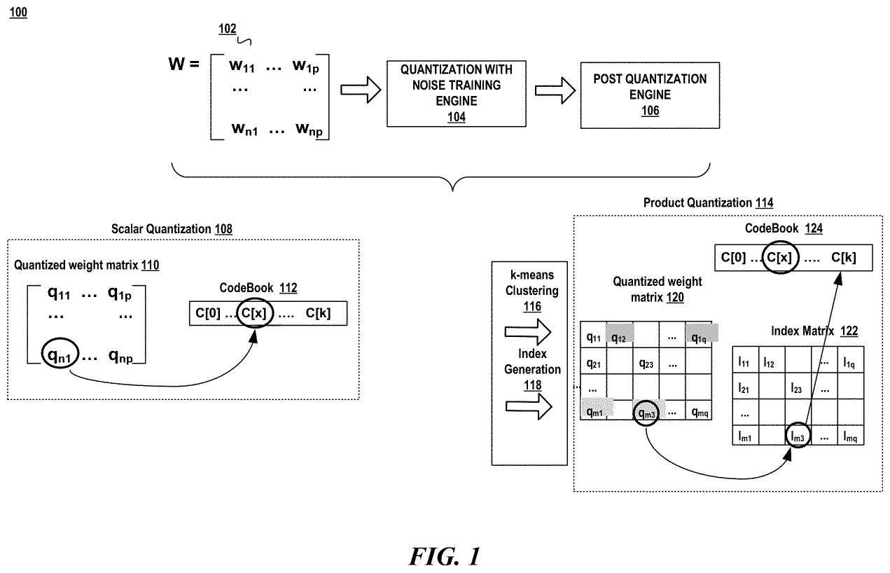

Turning to FIG. 1, there is shown the quantization process 100. During the training of a neural transformer model, a portion of each full-precision weight matrix 102 is quantized with noise through a quantization with noise training engine 104. The weights in a selected portion of each weight matrix are transformed into reduced bit-width weights. The quantization during training makes the model more resilient to quantization and reduces the noise or discrepancy between the quantized and full-precision model outputs. Upon completion of the training, all the weights of each weight matrix are post quantized into integer data types through the post quantization engine 106.

In the case of scalar quantization 108, each quantized weight matrix is transformed into a quantized weight matrix of indices 110 to a codebook 112. The full-precision floating point values in the matrix are rescaled into a uniformly-distributed range of values where the number of ranges k is based on the n-bit integer data type (k=2ⁿ⁻¹). For example, when the weights are quantized to INT8 data types, there are 255 ranges. There is a codebook for each weight matrix. Each codebook 112 stores the ranges of the quantized weights for each weight matrix.

Product quantization works on groups of weights taking into account the correlations between the weights in the weight matrix. A full-precision weight matrix of size n×p is decomposed into a number of sub-blocks of size m×q. Each weight matrix 120 has a codebook of centroids 124. The quantized weights of a sub-block are mapped to a particular centroid in the codebook 124. The centroid is computed through k-means clustering 116. An index matrix 122 is generated 118 and used to map a quantized weight qₘ₃ to a particular centroid C[Iₘ₃] of the codebook 126.

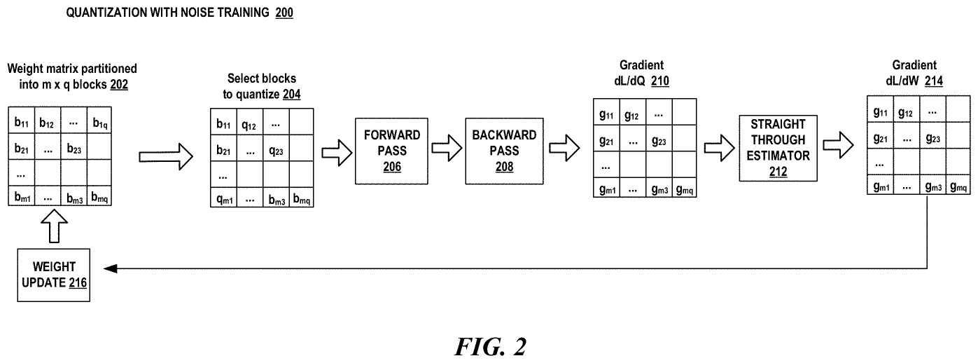

FIG. 2 shows the quantization with noise training 200. In quantization with noise training 200, a weight matrix having full-precision weights of size n×p is partitioned into a number of sub-blocks of size m×q 202. A randomly-selected portion of the sub-blocks are selected to quantize during training 204. During training, each sample is passed through the model in a forward pass 206 and backward pass 208, performing computations with the partially-quantized weight matrices. In the backward pass 208, a weight gradient is computed for each quantized value 210 through a straight through estimator 212. A weight gradient is computed for each non-quantized value 214 using a backpropagation algorithm. The gradients are used to update the weights 216. This process is repeated for each training sample of the training process.

Neural Transformer Model

In one aspect, the deep learning model is a neural transformer model with attention. Deep learning models differ from traditional machine learning models. Machine learning pertains to the use and development of computer systems that are able to learn and adapt without following explicit instructions, by using algorithms and statistical models to analyze and draw inferences from patterns in data. Machine learning uses different types of statistical methods to learn from data and to predict future decisions. Traditional machine learning includes classification models, data mining, Bayesian networks, Markov models, clustering, support vector machines, and visual data mapping. Deep learning differs from traditional machine learning since it uses multiple stages of data processing through many hidden layers of a neural network to learn and interpret the features and the relationships between the features. Deep learning embodies neural networks which differs from the traditional machine learning techniques that do not use neural networks.

A neural transformer model with attention is one type of deep learning that utilizes an attention mechanism. Attention directs the neural network to focus on a subset of features or tokens in an input sequence thereby learning different representations from the different positions of the tokens in an input sequence. The attention mechanism provides the model with a better capability to learn the task at hand thereby generating more accurate predictions. It should be noted that the term neural transformer model with attention and neural transformer model are used interchangeably.

There are different configurations of a neural transformer model. In one aspect, the customization techniques are applied to an encoder-decoder configuration of a neural transformer model. The encoder-decoder neural transformer model is used for machine translation tasks (i.e., sequence-to-sequence task) that translate an input sequence of one domain into an output sequence of a second domain, where a domain is a specific field or subject. A machine translation model learns a function that translates an input sequence into an output sequence.

In the context of code generation, the encoder-decoder neural transformer model is trained to translate a source code snippet of a first domain into a source code snippet of a second domain. A source code snippet includes various portions of source code as well as a docstring contained therein. For example, a model may be trained to translate a method signature (first domain) into a documentation string (second domain) for the method signature, translate a method signature (first domain) into a corresponding method body (second domain), translate a documentation string for a method (first domain) into the source code of the method body (second domain), translate a method body (first domain) into a method signature (second domain), translate a documentation string for a method body (first domain) into a method signature (second domain), translate a buggy source code snippet (first domain) into a repair patch for the buggy source code (second domain), and so forth.

An encoder-only neural transformer model is best suited for a source code classification task or code similarity task due to the type of attention used in the encoder. An encoder uses bi-directional attention which enables the encoder to learn the relationships of the tokens/subtokens in an input sequence both before and after their occurrence. Classifiers are trained to interpret a model's internal representation into a class label. Encoder-only neural transformer models are used to perform classification tasks and to perform code searches.

A decoder-only neural transformer model is an auto-regressive model that produces an output one element at a time based on the outputs of previous time steps. The decoder-only neural transformer model is best suited for code completion where the model predicts source code given a context, such as the immediately preceding source code tokens. Code completion is best suited for a decoder neural transformer model since it is an auto-regressive task that predicts an ordered sequence of tokens where the order depends on the preceding tokens in the sequence.

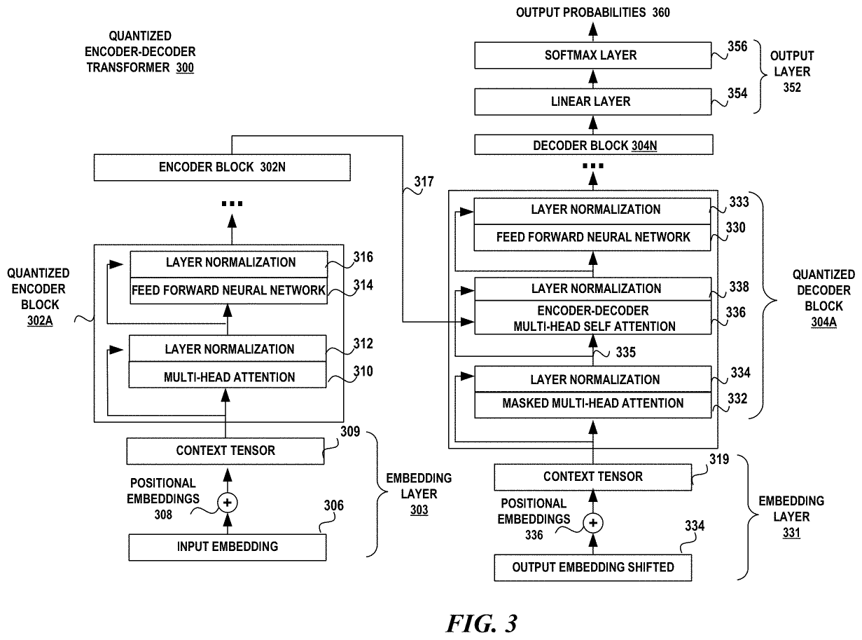

FIG. 3 shows an exemplary structure of the quantized neural transformer model with attention in an encoder-decoder configuration. The neural transformer model with attention 300 contains one or more encoder blocks 302A-302N (“302”) and one or more decoder blocks 304A-304N (“304”). A training dataset consists of a pair of context tensors 309, 319. The first encoder block 302A receives the context tensor 309 from the embedding layer 331 representing an input sequence in a first domain and the first decoder block 304A receives a context tensor 319 from the embedding layer 331 representing the translated sequence in a second domain.

An encoder block 302 consists of two layers. The first layer includes a multi-head attention component 310 followed by layer normalization component 312. The second layer includes a feed-forward neural network 314 and then a layer normalization component 316. The context tensor 309 is input into the multi-head attention layer 310 of the encoder block 302 with a residual connection to layer normalization 312. The output of the layer normalization 312 is input to the feed forward neural network 314 with another residual connection to layer normalization 316. The output of an encoder block 302 is a set of hidden representations. The set of hidden representations 317 is then sent through additional encoder blocks, if multiple encoder blocks exist. The hidden representations 317 of the last encoder block 302N are sent to the first decoder block 304A.

Attention is used to decide which parts of the input sequence are important for each subtoken, especially when decoding long sequences since the encoder is limited to encoding a fixed-size vector. Attention mechanisms gather information about the relevant context of a given subtoken and then encode that context into a vector which represents the subtoken. It is used to identity the relationships between subtokens in the long sequence while ignoring other subtokens that do not have much bearing on a given prediction.

The multi-head attention component 310 takes a context tensor 309 and weighs the relevance of each subtoken represented in the context tensor 309 to each other by generating attention weights for each subtoken in the context tensor 309. In one aspect, the attention function is scaled dot-product attention which is described mathematically as follows:

$$Attention ( Q , K , V ) = softmax ( \frac{{QK}^{T}}{\sqrt{{d}_{k}}} ) V ,$$

where the input consists of queries Q and keys K of dimension dₖ, and values V of dimension dᵥ. Q is a matrix that contains the query or vector representation of one subtoken in a sequence, K is the vector representations of all subtokens in the sequence, and Vis the vector representations of all the subtokens in the sequence.

The queries, keys and values are linearly projected h times in parallel with dᵥ output values which are concatenated to a final value:

MultiHead (Q, K, V)=Concat(head₁, . . . , headₕ) W^{o},

where headᵢ=Attention(QWᵢ^{Q}, KWᵢ^{K}, VWᵢ^{V}),

with parameter matrices Wᵢ^{Q}ϵ [symbol] ^{d}^{_{model}}^{Δd}^{ₖ}, Wᵢ^{K}ϵ [symbol] ^{d}^{_{model}}^{Δd}^{ₖ}, Wᵢ^{V} [symbol] ^{d}^{_{model}}^{Δd}^{ₖ}, and W^{O}ϵ [symbol] ^{hd}^{ᵥ}^{×d}^{_{model}}, where Wᵢ^{Q} are the query weights, Wᵢ^{K} are the key weights, Wᵢ^{V} are the value weights, and W^{O} are the weights of the concatenated output. Hence, the weights of the multi-head attention layer 310 are the parameter matrices, Wᵢ^{Q}, Wᵢ^{K}, Wᵢ^{V}, W^{O}.

In order to reduce the training time of the neural transformer, layer normalization is used between the layers. The layer normalization component normalizes the inputs across the features. The mean and standard deviation is computed across the feature dimensions. There is a first layer normalization 312 that precedes the feed forward neural network 314 and a second layer normalization 316 that follows the feed forward neural network 314. The feed-forward network layer 314 consists of two linear layers with a Gaussian Error Linear Unit (GeLU) activation function or a Rectified Linear Unit (ReLU) activation function in between both layers. The output of the top encoder block is a set of attention vectors K and V 317 which is used by the encoder-decoder multi-head attention layer 336 of the decoder block 304.

The decoder block 304 predicts each subtoken t in the target language one-by-one at each time step conditioned on all previously-generated target subtokens. t₁, . . . tᵢ₋₁. The decoder block 304 consists of three layers. The first layer includes a masked multi-head attention component 332 followed by a layer normalization component 334. The output of the layer normalization component 334 is input into the encoder-decoder multi-head attention component 336 with a residual connection 335 to layer normalization component 338. The second layer includes an encoder-decoder multi-head attention component 336 followed by a layer normalization component 338. The output of layer normalization component 338 is input into the feed forward neural network 330 with a residual connection to layer normalization component 333.

The third layer includes a feed forward neural network 330 followed by a layer normalization component 333. The feed-forward network layer 330 consists of two linear layers with an activation function (GeLU or ReLU) activation function in between both layers.

The masked multi-head attention component 332 receives the output embeddings of the previous timestep. The masked multi-head attention component 332 masks the output embeddings from future time steps. The encoder-decoder multi-head attention layer 336 receives queries from the previous decoder layer 335 and the memory keys and values 317 from the output of the encoder block 302. In this manner, the decoder block 304 can attend to every position of the input sequence. The feed-forward neural network 330 processes each output encoding separately. A layer normalization component 334, 338, 333 is used between the layers in order to normalizes the inputs across the features.

The output layer 352 includes a linear layer 354 and a softmax layer 356. The linear layer 354 is a feed-forward neural network that projects the vector produced by the stack of decoders into a logits vector. The softmax layer 356 then turns the scores of the logits vector into probabilities for each token in the vocabulary 358 which are positive and normalized.

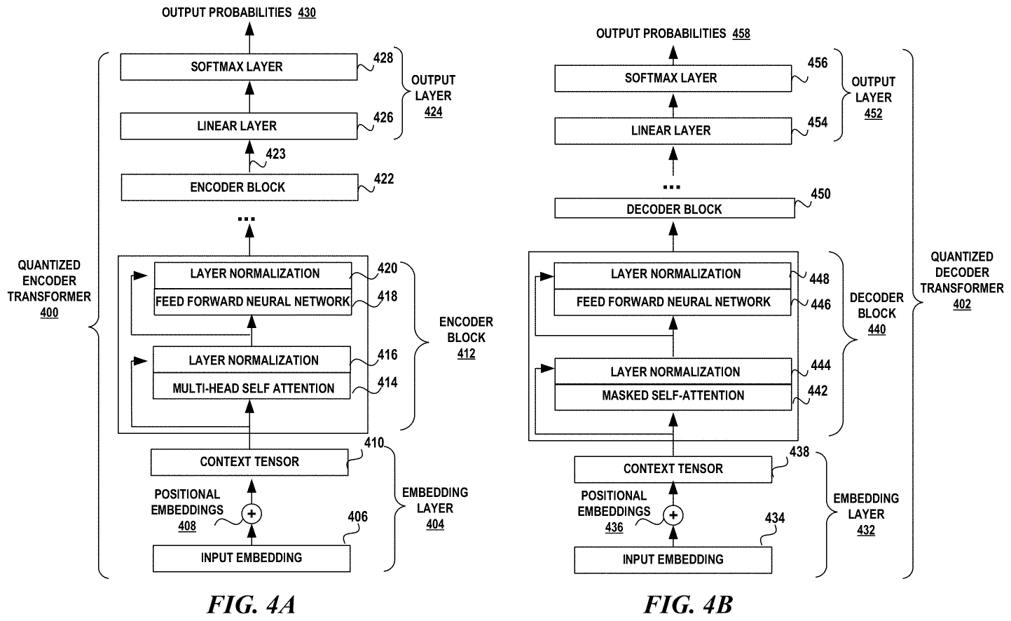

FIG. 4A illustrates a configuration of an encoder transformer. The encoder neural transformer 400 includes an embedding layer 404, one or more encoder blocks 412, and an output layer 424. The embedding layer 404 includes input embeddings of an input sequence of the training dataset 406 and positional embeddings 408 that represents an order of the tokens/subtokens in an input sequence. The input embeddings 406 and the positional embeddings 408 are combined to form a context tensor 410.

An encoder block 412 consists of two layers. The first layer includes a multi-head self-attention component 414 followed by layer normalization component 416. The second layer includes a feed-forward neural network 418 followed by a layer normalization component 420. The context tensor 410 is input into the multi-head self-attention layer 414 of the encoder block 412 with a residual connection to layer normalization 416. The output of the layer normalization 416 is input to the feed forward neural network 418 with another residual connection to layer normalization 420. The output of each encoder block is a set of hidden representations 423. The set of hidden representations 423 are then sent through additional encoder blocks, if multiple encoder blocks exist.

The output layer 424 includes a linear layer 426 and a softmax layer 428. The linear layer 426 projects the vector produced by the stack of decoders into a logits vector. The softmax layer 428 then turns the scores of the logits vector into output probabilities 430 for each token in the vocabulary which are positive and normalized.

FIG. 4B illustrates an exemplary configuration of the decoder neural transformer model. The decoder neural transformer model 402 includes an input layer 432, one or more decoder blocks 440, and an output layer 452. A decoder block 440 consists of two layers. The first layer includes a masked self-attention component 442 followed by a layer normalization component 444. The input to the masked multi-head self-attention component 442 has a residual connection to layer normalization 444. The output of layer normalization 444 is input into the feed forward neural network 446 with a residual connection to layer normalization component 448. The output of the feed forward neural network is input into layer normalization component 448.

Each token/subtoken flows through all the decoder blocks along its own path. The masked self-attention component 442 allows the neural network 446 to focus on certain features or inputs. The inputs to the decoder block 434 are added with the positional embeddings 436 forming context tensor 438. The decoder block 440 predicts each token/subtoken t₁ in the target language one-by-one at each time step conditioned on all previously-generated target tokens/subtokens t₁, . . . tᵢ₋₁.

The masked self-attention component 442 masks the output embeddings from future time steps. The feed-forward neural network 446 processes each output embedding separately. A layer normalization component 444, 448 is used between the layers in order to normalize the inputs across the features.

The output layer 452 includes a linear layer 454 and a softmax layer 456. The linear layer 454 projects the vector produced by the stack of decoders into a logits vector. The softmax layer 456 then turns the scores of the logits vector into output probabilities 458 for each token in the vocabulary which are positive and normalized.

Weights

The training of a neural transformer model is a process where the model learns which weights and biases (i.e., parameters) minimize a cost function which results in a better fitting model. The weights that are quantized are used in various layers of the encoder and decoder blocks and the subtoken and positional embeddings.

Referring to FIGS. 3 and 4A-4B, the embedding layer 303, 331, 404, 432 generates an input sequence of embeddings 306, 334, 406, 434 that are applied to the model. Given an input sequence of tokens X, the embedding layer 303, 331, 404, 432 converts the input sequence into an embedding input tensor H⁰ϵ [symbol] ^{|X|×dh}, where |X| is the input sequence length and dₕ is the embedding dimension. Each row j of H⁰ is obtained as H⁰ⱼ=EmbeddingLookupₜₒₖₑₙ (xⱼ, V)+EmbeddingLookupₚₒₛᵢₜᵢₒₙ (j,P), where EmbeddingLookupₜₒₖₑₙ performed by an embedding engine to search in an embedding store for the embedding of subtoken xⱼ, where EmbeddingLookupₚₒₛᵢₜᵣₒₙ is performed by the embedding engine to search in the embedding store for the embedding of position j, where V is the subtoken vocabulary, xᵢ is a subtoken at position j of the input sequence, and P is the maximum sequence length or the maximum number of positions in a sequence. EmbeddingLookupₜₒₖₑₙ (xⱼ, V) returns the dimensional row, dₕ, of the embedding matrix Ws that corresponds to xⱼ and EmbeddingLookupₚₒₛᵢₜᵢₒₙ(j, P) returns the dimensional row of the embedding matrix Wp that corresponds to the position j.

The model applies n transformer blocks (i.e., encoder and/or decoder blocks) over the input embeddings to produce contextual representations: Hⁿ=transformerₙ(Hⁿ⁻¹), nϵ[1, N]. Each transformer block includes a multi-headed self-attention layer followed by a feed forward neural network (i.e., multi-layer perceptron MLP). Each of these layers is followed by skip-connection and layer normalization operation, LayerNorm. Specifically, for the n-th transformer block:

Gⁿ=LayerNorm (MultiHeadAttn (Hⁿ⁻¹)+Hⁿ⁻¹,

Hⁿ=LayerNorm (FeedForward (Gⁿ)+Gⁿ),

where MultHeadAttn is operation of the multi-head self-attention layers 310, 332, 414, 442, and FeedForward is the operation of the feed forward neural network layers 314, 330, 418, 446, and LayerNorm is the operation of the layer normalization layers 312, 316, 334, 333, 338, 416, 420, 444, 448.

For the n-th transformer layer, the multi-headed self-attention is parameterized with matrices Wᵢ^{Q}, Wᵢ^{K}, Wᵢ^{v}ϵR^{dh×dk}, which are used to linearly project the Hⁿ⁻¹ to obtain query, key and value matrices:

Qᵢ=Hⁿ⁻¹*Wᵢ^{Q},Kᵢ=Hⁿ⁻¹*Wᵢ^{K},Vᵢ=Hⁿ⁻¹*Wᵢ^{V}.

The output of the multi-head attention operation is obtained as:

$${head}_{i} = softmax ( \frac{{Q}_{i} {K}_{i}^{T}}{\sqrt{{d}_{K}}} + M ) {V}_{i} , \\ {G}^{n} = [ {head}_{1} , {head}_{2} , … {head}_{u} ] {W}_{n}^{O} ,$$

where the previous layer's output Hⁿ⁻¹ϵ [symbol] ^{|X|×dh} is linearly projected to a triplet of queries, keys, and values using model parameters Wᵢ^{Q}, Wᵢ^{K}, Wᵢ^{v}ϵR^{dh×dk}, respectively, where u is the number of self-attention heads, dₖ is the dimension of a head, and Wₙ^{O}ϵ [symbol] ^{dh×dh} are the model parameters, where Mϵ [symbol] ^{dh×dh} is a mask matrix, where [ . . . ] represents a concatenation operation.

Gⁿ serves as input to the feed forward neural network layer 314, 330, 418, 446 which includes an activation layer. The feed-forward neural network layer 314, 330, 418, 446 performs the computation Zⁿ=W₂^{T} GELU (W₁^{T}+b₁)+b₂, where W₁ϵ [symbol] ^{dh×dh}, W₂ϵ [symbol] ^{4dh×dh} are weight matrices parametrizing the feed-forward neural network layer.

The output of the feed-forward neural network layer which is also the output of an encoder block and decoder block is obtained by applying the skip-connection and layer normalization operation:

Hⁿ=LayerNorm(Zⁿ+Gⁿ),

where the LayerNorm function is defined as:

$$LayerNorm ( {Z}^{n} , γ , β ) = γ \frac{{Z}^{n} - {u}_{{Z}^{n}}}{{σ}_{{Z}_{n}}} + β , where γ , β ∈ {ℛ}^{d} , and \\ where {μ}_{{Z}^{n}} = \frac{1}{k} {\sum }_{i = 1}^{k} {Z}_{n}^{i} , and where {σ}_{{Z}^{n}} = \sqrt{\frac{1}{k} {\sum }_{i = 1}^{k} {( {Z}_{n}^{i} - {μ}_{{Z}^{n}} )}^{2}} .$$

The training of the feed forward neural network 314, 330, 418, 446, consists of the forward pass, loss calculation [symbol] , backward pass to extract the gradient of the loss function ∇ [symbol] over the trainable parameters via chain-rule differentiation and the weight update. The weight update is performed using the standard stochastic gradient descent formulation:

W^{k}=W^{k-1}−λ∇ [symbol] (W^{k-1}).

Attention now turns to a more detailed description of the quantization methods.

Methods

Attention now turns to description of the various exemplary methods that utilize the system and device disclosed herein. Operations for the aspects may be further described with reference to various exemplary methods. It may be appreciated that the representative methods do not necessarily have to be executed in the order presented, or in any particular order, unless otherwise indicated. Moreover, various activities described with respect to the methods can be executed in serial or parallel fashion, or any combination of serial and parallel operations. In one or more aspects, the method illustrates operations for the systems and devices disclosed herein.

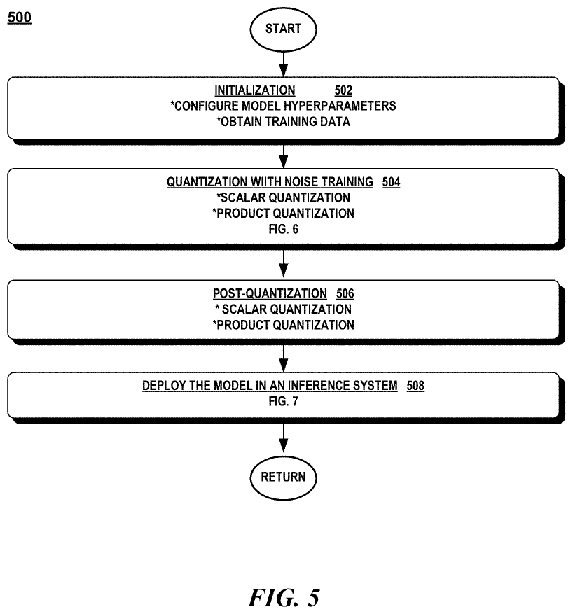

Turning to FIG. 5, initially, the hyperparameters that define the initial size of the weight matrices are determined. In one aspect, the hyperparameters may include the following: (1) the dimensions of the subtoken and position embedding layers: 30000×768, and 1024×768 respectively; (2) the configuration of the neural transformer model: the number of encoder blocks and/or the number of decoder blocks; and (3) the number of attention heads for the self-attention layers. These hyperparameters define the initial size of the weight matrices. (Collectively, block 502).

In addition, the training dataset is obtained. The training dataset may be obtained from source code programs stored in a source code repository or from other sources. In the case of an encoder code engineering task, the training dataset may include source code snippets and a corresponding label. For a decoder code engineering task, the training dataset may include source code snippets and a given context and for the encoder-decoder code engineering task, the training dataset may include source code from a first domain and the corresponding source code of a related second domain. (Collectively, block 502).

A model is then trained with the training dataset through quantization with noise training (block 504). Upon completion of the training, each weight matrix is fully-quantized (block 506) and the model is deployed in an inference system (block 508).

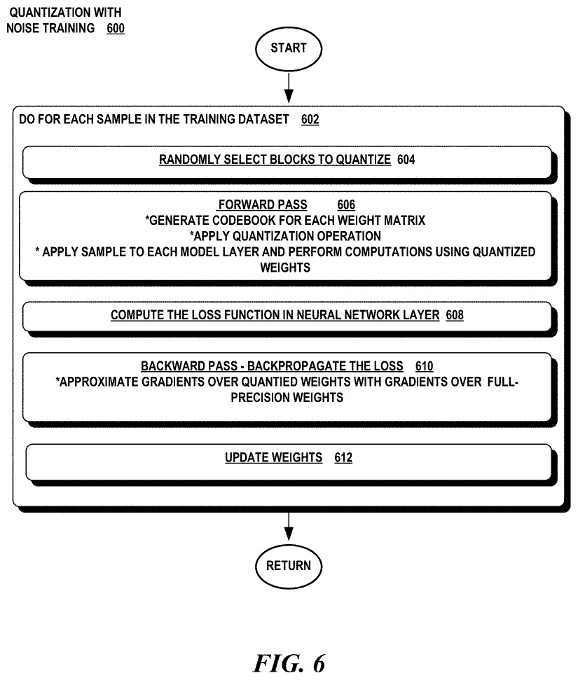

FIG. 6 illustrates an exemplary method for the quantization with noise training 600. Initially, the weight matrices are initialized with random values and partitioned into sub-blocks. A subset of the sub-blocks is selected for quantization while the remaining sub-blocks are unquantized. The values in the selected sub-blocks values may be converted into a fixed-point representation, such as an INT8 or INT4 data type.

In the case of scalar quantization, a weight matrix of dimension, n×p, is partitioned into sub-matrices or sub-blocks of size m×q blocks. Each sub-block is represented as block bₖₗ, where k represents a row of the weight matrix, and l represents a column of the weight matrix. A portion of the sub-blocks is selected and quantized.

The quantization with noise training engine divides the range of weights into a number of intervals and each interval is represented by a distinct codeword c of codebook. Each quantized sub-block, bₖₗ, consists of a single weight Wₖₗ which is mapped to a codeword c using the following transformation:

$$z ↦ round ( {W}_{kl} / s + z ) , \\ where S = \frac{max W - min W}{{2}^{N} - 1}$$

is a scale defined based on a clipping range from the range of weights in the matrix W and the number of bits (e.g., N=8 for INT8), and

where shift z is defined based on the minimum value of W: z=round (min W/s).

Product quantization works on groups of weights taking into account the correlations between the weights in the weight matrix. A full-precision weight matrix W of dimension, n×p, is partitioned into m×q sub-blocks. K-means clustering is used to map each sub-block bₖₗ into a codeword c[k] of a codebook. There are k codewords in the codebook, C={c[1], . . . , c[k]}, and a codebook for each weight matrix W. The codebook contains the cluster centroids. The k-means clustering algorithm maps a block bₖₗ into a codeword c[k] based on the nearest mean or cluster centroid.

Initially, the number of clusters is selected based on the quantization strategy. For example, when using INT8 data types, the number of centroids or clusters is k=2^{N}=2⁸=256 centroids or codewords, where N=8 bits. The k-means clustering algorithm selects K random weights from a weight matrix as centroids in a codeword. Each weight is then assigned to the closest codeword centroid based on the closest distance between the weight and the centroid. The centroids of each newly-formed codeword are then recomputed. The process repeats assigning new weights to the closest cluster centroid and recomputing the centroids until the centroids do not change, the weights remain in the same codeword, or a maximum number of iterations is reached.

Next, the index matrix is generated. The centroid indices into the codebook for each sub-block is stored in an index matrix I. The matrix W is compressed by assigning each sub-block bₖₗ to a codeword c in codebook C and storing the resulting codebook and index matrix element Iₖₗ instead of the actual weight matrix W. During inference, the original matrix is reconstructed by looking up the codewords given the indices k,l as follows: bₖₗ=c[Iₖₗ].

The goal of the product quantization is to minimize the distortion between the original matrix W and the quantized matrix Ŵ. In one aspect, the distortion is computed as the residual sum of squares: ∥W−Ŵ∥₂²=Σ_{k,l}∥bₖₗ−c[Iₖₗ]∥₂², which is an estimation of the difference between the weights of the two matrices.

The training process is described with respect to the encoder-decoder configuration of a neural transformer model. However, it should be understood that the same process applies to the other configurations in a similar manner.

The training of the model applies each training sample in a training dataset to each layer of the model (block 602). The quantization with noise training engine randomly selects the block in each weight matrix at each layer to quantize as each training sample is applied to the model (block 604). Thereafter, the training consists of a forward pass (block 606), a loss calculation (block 608), and a backward pass (block 610).

In the forward pass (block 606), a codebook is generated for each weight matrix. The quantization operation is applied to the selected block of each weight matrix in each layer (block 606). The sample of the training dataset is applied to each layer of the model to perform the computations of each layer as noted above (block 606).

During training, an error loss is computed which is used to optimize the weights of the model (block 608). The loss is then used to adjust the model weights during training in order to minimize the loss function. The backward pass backpropagates the loss to each layer where a gradient is computed (block 610) and used to update the weights of that layer (block 612). The process of adjusting or updating the weights is considered model training and as the model keeps training and the loss is getting minimized, the model is learning.

In the encoder-decoder configuration of the deep learning model, the training dataset contains input sequences consisting of a pair of source code snippets. Each input sequence of the pair is parsed into a concrete syntax tree from which a sequence of tokens is extracted and encoded into subtokens. Each token/subtoken in the sequence is replaced with its respective subtoken embedding and a positional embedding. A context tensor is formed by combining the sequence of subtoken embeddings with its corresponding positional embeddings.

The context tensor is then applied to each layer of the model. In one aspect, a training dataset consists of a large number of pairs of context tensors that are partitioned into smaller batches. The training is iterative with each batch running through the training process. The entire batch is passed through each of the encoder and decoder blocks in multiple iterations. Each training iteration includes forward propagation (block 606), loss calculation (block 608), backpropagation (block 610) steps followed by updating the weights (block 612).

The first encoder block of the neural transformer model takes the first context tensor of a pair as input and passes it through the multiple layers of multi-head attention, layer normalization, feed-forward neural network, and layer normalization to finally produce a set of hidden representations. If there are additional encoder blocks, the output of each encoder block is passed onto the next encoder block with the output of the last encoder block producing the set of hidden representations. The set of hidden representations is passed onto each decoder block. (Collectively, block 606).

The first decoder block of the model takes the second context tensor of the pair as input and passes it to the masked multi-head attention layer. Starting with the first token of the context tensor, the subtokens are passed through the self-attention and normalization layers and into the encoder-decoder attention layer, serving as the query for encoder-decoder attention, where the key and value pairs for the attention are the outputs of the last encoder block. (Collectively, block 606).

The feed forward neural networks in the encoder blocks and the decoder blocks are trained iteratively, making multiple passes over the training dataset before converging to a minimum. Each training iteration includes forward propagation (block 606), loss calculation (block 608), backpropagation (block 610) steps followed by updating the weights by calculating the weight gradients (block 612).

The loss function estimates the loss or error which is used to compare how good or bad the predicted results are (block 608). In one aspect, a categorical cross-entropy loss function is used. Once the loss is calculated (block 608), it is propagated backwards to the hidden layer that contributed directly to the output (block 610).

In backpropagation, the partial derivatives of the loss function with respect to the weights and biases are determined starting from the feed-forward neural network layer back to the embedding layer of the first transformer block. A backpropagation algorithm computes the gradient of the loss function for a single weight by the chain rule. The weight gradients are calculated as the difference between the old values and the new values of the weights. The weights are adjusted to make the loss as small as possible using a gradient descent technique. (Collectively, block 610).

The partial-derivative of the loss by the quantized weight will be zero so no gradient will be computed which results in the model not learning anything. In order to account for the quantized weights, a full precision gradient is computed for the non-quantized weights. For the quantized weights, a straight-through estimator is used in the backward pass. A straight-through estimator is an estimation of a gradient by ignoring the derivative of the activation function and instead passing on the incoming gradient as if it was the identity function. (Collectively, block 610).

At the completion of each batch, the weights of the neural transformer model are updated (block 612). Upon completion of the training process, the model is configured with the quantized weight matrices and deployed in an inference system.

Inference Process

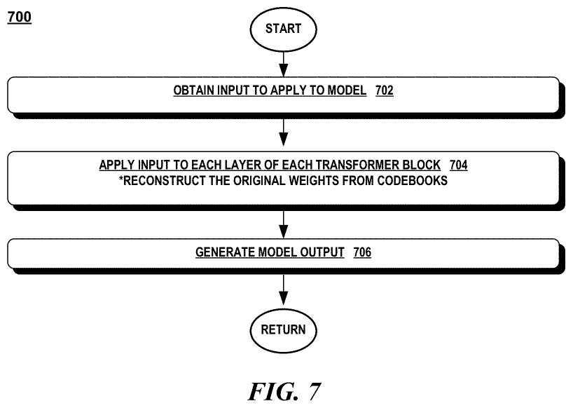

FIG. 7 shows an exemplary embodiment of a method 700 of the deep learning model in an inference system. When the model is deployed in an inference system, the model is invoked by a software application which passes an input to the model (block 702) and which receives the model's output. The input is source code which is parsed into tokens and transformed into an input sequence of subtoken and positional embeddings. The embedding layer obtains the subtoken and positional embeddings from the subtoken and positional embedding matrices. The input sequence is then passed to the first layer of the first transformer block and processed accordingly. At each layer computations are made using the appropriate weights and the output of each layer is passed onto the next layer or transformer block (block 704). At the last layer of the output layer, the output probabilities are computed and output back to the application that invoked the model. (Collectively, block 706).

At each layer of the model, the quantized weights are used to reconstruct the original weights. The reconstruction does not generate the original weight but a value that is close to the original value with a small noise factor.

To obtain a scalar-quantized weight, the indices of the weight in the weight matrix, kl, are mapped to a codeword c in the codebook from which the original weight is reconstructed as follows: c=(round (Wₖₗ/s+z)−z)×s, where s is defined based on the clipping range which is the range of weights in the matrix W and the number of bits in the integer data type; and z is defined based on the minimum value of W as z=round(min W/s). (Collectively, block 704).

To obtain a product-quantized weight, the indices of the weight in the weight matrix kl map into a value in the index matrix Iₖₗ that maps to the centroid of a codebook c[Iₖₗ] that represents the weight as follows: \hat{b}ₖₗ=c[Iₖₗ]. (Collectively, block 704).

The computations in each layer are computed using the reconstructed values and the outputs of each layer are passed to the next layer in a transformer block or the next transformer block until the process is finished. (Collectively, block 704).

In some scenarios, the software application uses a beam search to generate the top k output distributions. A beam search is an approximation algorithm that generates the most promising output distribution. Beam search uses a breadth-first search to build a search tree. The search tree is composed of nodes at one or more inference levels. Each node represents a probability distribution generated by the neural transformer model for the subtokens in the model vocabulary. At each level, only the top k subtokens having the highest probabilities from the output distribution generated by the neural transformer model are expanded to the next inference level. The variable k is preconfigured and referred to as the beam width. Each of the k subtokens is then expanded into a search that updates the current context sequence with the selected subtoken to input into the neural transformer model to generate an additional probability distribution for the next subtoken in a sequence. This process is repeated until an appropriate end of source code token is predicted as being the next likely subtoken candidate. (Collectively block 704).

At the completion of the inference process, the model's output is generated and utilized by the software application for the intended task (block 706).

Exemplary Operating Environment

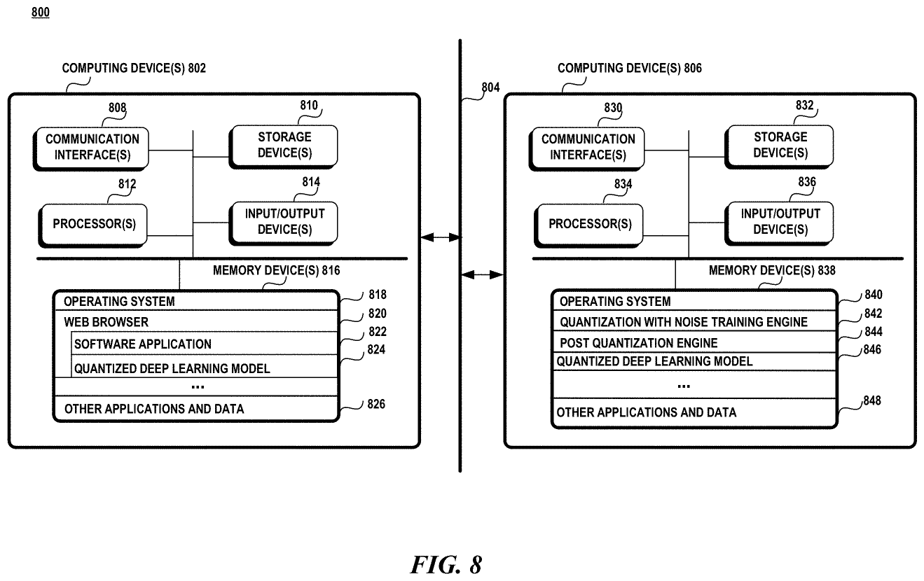

Attention now turns to a discussion of an exemplary operating environment. FIG. 8 illustrates an exemplary operating environment 800 in which one or more computing devices 802, 806 are used in a model quantization system. In one aspect, a first computing device 806 generates the model which is then packaged into a software component used by a software application on a second computing device 802. In alternate embodiments, the system may be configured as a cloud service that generates a quantized deep learning model as a service for client devices. However, it should be noted that the aspects disclosed herein are not constrained to any particular configuration of devices and that other variations are possible.

A computing device 802, 806 may be any type of electronic device, such as, without limitation, a mobile device, a personal digital assistant, a mobile computing device, a smart phone, a cellular telephone, a handheld computer, a server, a server array or server farm, a web server, a network server, a blade server, an Internet server, a work station, a mini-computer, a mainframe computer, a supercomputer, a network appliance, a web appliance, a distributed computing system, multiprocessor systems, or combination thereof. The operating environment 800 may be configured in a network environment, a distributed environment, a multi-processor environment, or a stand-alone computing device having access to remote or local storage devices.

A computing device 802, 806 may include one or more processors 812, 834, one or more communication interfaces 808, 830, one or more storage devices 810, 832, one or more input/output devices 814, 836, and one or more memory devices or memories 816, 838. A processor 812, 834 may be any commercially available or customized processor and may include dual microprocessors and multi-processor architectures. A communication interface 808, 830 facilitates wired or wireless communications between the computing devices and other devices. A storage device 810, 832 may be computer-readable medium that does not contain propagating signals, such as modulated data signals transmitted through a carrier wave. Examples of a storage device 810, 832 include without limitation RAM, ROM, EEPROM, flash memory or other memory technology, CD-ROM, digital versatile disks (DVD), or other optical storage, magnetic cassettes, magnetic tape, magnetic disk storage, all of which do not contain propagating signals, such as modulated data signals transmitted through a carrier wave. There may be multiple storage devices 810, 832 in a computing device 802, 806. The input/output devices 814, 836 may include a keyboard, mouse, pen, voice input device, touch input device, display, speakers, printers, etc., and any combination thereof.

A memory device or memory 816, 838 may be any non-transitory computer-readable storage media that may store executable procedures, applications, and data. The computer-readable storage media does not pertain to propagated signals, such as modulated data signals transmitted through a carrier wave. It may be any type of non-transitory memory device (e.g., random access memory, read-only memory, etc.), magnetic storage, volatile storage, non-volatile storage, optical storage, DVD, CD, floppy disk drive, etc. that does not pertain to propagated signals, such as modulated data signals transmitted through a carrier wave. A memory device 816, 838 may also include one or more external storage devices or remotely located storage devices that do not pertain to propagated signals, such as modulated data signals transmitted through a carrier wave.

The memory device or memory 816, 838 may contain instructions, components, and data. A component is a software program that performs a specific function and is otherwise known as a module, program, component, and/or application. Memory device 816 may include an operating system 818, a web browser 820 having a software application 822 and a quantized deep learning model 824, and other applications and data 826. Memory device 838 may include an operating system 840, a quantization with noise training engine 842, a post quantization engine 844, a quantized deep learning model 846, and other applications and data 848.

The computing devices 802, 806 may be communicatively coupled via a network 806. The network 806 may be configured as an ad hoc network, an intranet, an extranet, a virtual private network (VPN), a local area network (LAN), a wireless LAN (WLAN), a wide area network (WAN), a wireless WAN (WWAN), a metropolitan network (MAN), the Internet, a portions of the Public Switched Telephone Network (PSTN), plain old telephone service (POTS) network, a wireless network, a WiFi® network, or any other type of network or combination of networks.

The network 806 may employ a variety of wired and/or wireless communication protocols and/or technologies. Various generations of different communication protocols and/or technologies that may be employed by a network may include, without limitation, Global System for Mobile Communication (GSM), General Packet Radio Services (GPRS), Enhanced Data GSM Environment (EDGE), Code Division Multiple Access (CDMA), Wideband Code Division Multiple Access (W-CDMA), Code Division Multiple Access 2000, (CDMA-2000), High Speed Downlink Packet Access (HSDPA), Long Term Evolution (LTE), Universal Mobile Telecommunications System (UMTS), Evolution-Data Optimized (Ev-DO), Worldwide Interoperability for Microwave Access (WiMax), Time Division Multiple Access (TDMA), Orthogonal Frequency Division Multiplexing (OFDM), Ultra-Wide Band (UWB), Wireless Application Protocol (WAP), User Datagram Protocol (UDP), Transmission Control Protocol/Internet Protocol (TCP/IP), any portion of the Open Systems Interconnection (OSI) model protocols, Session Initiated Protocol/Real-Time Transport Protocol (SIP/RTP), Short Message Service (SMS), Multimedia Messaging Service (MMS), or any other communication protocols and/or technologies.

Technical Effect

Aspects of the subject matter disclosed herein pertain to the technical problem of minimizing the amount of computing resources needed to execute a deep learning model. The size of the deep learning model affects the functioning of the computing device and is dominated by the size of its full-precision floating point weight matrices. Deep learning models with large-sized weight matrices consume an enormous amount of computing resources, training time and execution time to perform a target software engineering task.

The technical features associated with addressing this problem are the techniques used to quantize the model's weight matrices to reduce the model size, training time, and inference time needed by a computing device to execute the model. The technical effect achieved is the reduction of the computing resources needed by computing device to execute the model thereby making the model available to resource-constrained computing devices, such as mobile devices and IoT devices.

### CONCLUSION

A system is disclosed comprising a processor and a memory. The memory stores a program configured to be executed by the processor. The program including instructions to perform acts that: obtain a deep learning model having a plurality of layers, each layer having a plurality of weight matrices; train the deep learning model to determine a value for each weight of each of the plurality of weight matrices that minimizes a loss function through application of training samples to each layer of the plurality of layers, wherein each weight matrix includes a first portion and a second portion, wherein the first portion of each weight matrix is quantized with reduced bit-width weights, wherein the second portion includes full-precision floating point values; and upon completion of the training of the deep learning model, quantize each weight matrix of the plurality of weight matrices with reduced bit-width weights.

In an aspect, the program includes instructions to perform acts that: generate a codebook for each of the plurality of weight matrices, wherein the codebook includes a plurality of uniformly-distributed range of values. In an aspect, the program includes instructions to perform acts that: generate a codebook for each of the plurality of weight matrices, wherein the codebook includes a plurality of centroids, wherein each centroid of the plurality of centroids is generated from K-means clustering of weights of a respective weight matrix.

In an aspect, the program includes instructions to perform acts that: generate an index matrix that maps a weight of a respective weight matrix into a select one of the centroids of the codebook. In an aspect, the program includes instructions to perform acts that: randomly select weights in the first portion of each weight matrix to quantized with reduced bit-widths. In an aspect, the reduced bit-width weights are fixed-point integers. In an aspect, the reduced bit-width weights are INT4 or INT8 data types. In an aspect, the deep learning model is a neural transformer model with attention.

A computer-implemented method is disclosed, comprising: obtaining a deep learning model having a plurality of layers, each layer having a plurality of weight matrices; training the deep learning model to learn values for each weight of the plurality of weight matrices that minimize a loss function by: selecting a first portion of each weight matrix at each layer to quantize; quantizing weights of the first portion of each weight matrix with fixed-point integer representations; performing computations at each layer with the fixed-point integer representations; computing an error loss from the computations; determining a full-precision gradient to update the quantized weights using an estimator; determining a full-precision gradient to update unquantized weights using stochastic gradient descent; and updating the values of the weights of each weight matrix based on the full-precision gradient; and upon completion of the training, quantizing each weight of each weight matrix into a fixed-point integer representation.

In an aspect, the method further comprises decomposing each weight matrix into sub-blocks; and randomly choosing a select one of the sub-blocks as the first portion. In an aspect, the method further comprises generating a codebook for a first weight matrix, wherein the codebook includes a plurality of uniformly-distributed range of values based on an n-bit representation of the fixed-point integer representation; and mapping a weight of the first weight matrix into a value of the codebook.

In an aspect, the method further comprises: generating a codebook for a second weight matrix, wherein the codebook includes a plurality of centroids, wherein each centroid of the plurality of centroids is generated from K-means clustering of weights of the second weight matrix. In an aspect, the method further comprises: generating an index matrix to map a weight of the second weight matrix into the select centroid of the codebook. In an aspect, the fixed-point integer representations are INT4 or INT8 data types. In an aspect, the deep learning model is a neural transformer model with attention.

A device is disclosed comprising a processor and a memory. The memory includes instructions that when executed on the processor performs actions that: configure a deep learning model with a plurality of layers, each of the plurality of layers having at least one weight matrix, the at least one weight matrix including a plurality of weights; train the deep learning model to learn to generate source code by computing values for each of the plurality of weights that minimizes an error function, wherein during training of the deep learning model: select a first portion of the at least one weight matrix to quantize with integer data types and selecting a second portion of the at least one weight matrix expressed as full-precision floating point values; determine values for weights of the at least one weight matrix through multiple iterations of a forward pass, backward pass, and weight update using the first portion of weights and the second portion of weights; and upon completion of the training, quantizing all weights of the at least one weight matrix to integer data types.

In an aspect, the memory includes further instructions that when executed on the processor performs actions of: generating a codebook for the at least one weight matrix, wherein the codebook includes a plurality of centroids; and computing the plurality of centroids for the at least one weight matrix using K-means clustering. In an aspect, the memory includes instructions that when executed on the processor performs actions of: generating an index matrix that maps a quantized weight of the at least one weight matrix into a centroid.

In an aspect, the quantized weights are INT4 or INT8 data types. In an aspect, the deep learning model is a neural transformer model with attention.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Operations for the aspects may be further described with reference to various exemplary methods. It may be appreciated that the representative methods do not necessarily have to be executed in the order presented, or in any particular order, unless otherwise indicated. Moreover, various activities described with respect to the methods can be executed in serial or parallel fashion, or any combination of serial and parallel operations. In one or more aspects, the method illustrates operations for the systems and devices disclosed herein.

What is claimed:

1. A system comprising:
a processor; and
a memory that stores a program configured to be executed by the processor, the program including instructions to perform acts that:
obtain a deep learning model having a plurality of layers, each layer having a plurality of weight matrices;
train the deep learning model to determine a value for each weight of each of the plurality of weight matrices that minimizes a loss function through application of training samples to each layer of the plurality of layers, wherein each weight matrix includes a first portion and a second portion, wherein the first portion of each weight matrix is quantized with reduced bit-width weights, wherein the second portion includes full-precision floating point values; and
upon completion of the training of the deep learning model, quantize each weight matrix of the plurality of weight matrices with reduced bit-width weights.

2. The system of claim 1, wherein the program includes instructions to perform acts that:
generate a codebook for each of the plurality of weight matrices, wherein the codebook includes a plurality of uniformly-distributed range of values.

3. The system of claim 1, wherein the program includes instructions to perform acts that:
generate a codebook for each of the plurality of weight matrices, wherein the codebook includes a plurality of centroids, wherein each centroid of the plurality of centroids is generated from K-means clustering of weights of a respective weight matrix.

4. The system of claim 3, wherein the program includes instructions to perform acts that:
generate an index matrix that maps a weight of a respective weight matrix into a select one of the centroids of the codebook.

5. The system of claim 1, wherein the program includes instructions to perform acts that:
randomly select weights in the first portion of each weight matrix to quantized with reduced bit-widths.

6. The system of claim 1, wherein the reduced bit-width weights are fixed-point integers.

7. The system of claim 1, wherein the reduced bit-width weights are INT4 or INT8 data types.

8. The system of claim 1, wherein the deep learning model is a neural transformer model with attention.

9. A computer-implemented method, comprising:
obtaining a deep learning model having a plurality of layers, each layer having a plurality of weight matrices;
training the deep learning model to learn values for each weight of the plurality of weight matrices that minimize a loss function by:
selecting a first portion of each weight matrix at each layer to quantize;
quantizing weights of the first portion of each weight matrix with fixed-point integer representations;
performing computations at each layer with the fixed-point integer representations;
computing an error loss from the computations;
determining a full-precision gradient to update the quantized weights using an estimator;
determining a full-precision gradient to update unquantized weights using stochastic gradient descent; and
updating the values of the weights of each weight matrix based on the full-precision gradient; and
upon completion of the training, quantizing each weight of each weight matrix into a fixed-point integer representation.

10. The method of claim 9, further comprising:
decomposing each weight matrix into sub-blocks; and
randomly choosing a select one of the sub-blocks as the first portion.

11. The method of claim 9, further comprising:
generating a codebook for a first weight matrix, wherein the codebook includes a plurality of uniformly-distributed range of values based on an n-bit representation of the fixed-point integer representation; and
mapping a weight of the first weight matrix into a value of the codebook.

12. The method of claim 9, further comprising:
generating a codebook for a second weight matrix, wherein the codebook includes a plurality of centroids, wherein each centroid of the plurality of centroids is generated from K-means clustering of weights of the second weight matrix.

13. The method of claim 12, further comprising:
generating an index matrix to map a weight of the second weight matrix into the select centroid of the codebook.

14. The method of claim 9, wherein the fixed-point integer representations are INT4 or INT8 data types.

15. The method of claim 9, wherein the deep learning model is a neural transformer model with attention.

16. A device comprising:
a processor and a memory;
wherein the memory includes instructions that when executed on the processor performs actions that:
configure a deep learning model with a plurality of layers, each of the plurality of layers having at least one weight matrix, the at least one weight matrix including a plurality of weights;
train the deep learning model to learn to generate source code by computing values for each of the plurality of weights that minimizes an error function, wherein during training of the deep learning model:
select a first portion of the at least one weight matrix to quantize with integer data types and selecting a second portion of the at least one weight matrix expressed as full-precision floating point values;
determine values for weights of the at least one weight matrix through multiple iterations of a forward pass, backward pass, and weight update using the first portion of weights and the second portion of weights; and
upon completion of the training, quantizing all weights of the at least one weight matrix to integer data types.

17. The device of claim 16, wherein the memory includes instructions that when executed on the processor performs actions that:
generating a codebook for the at least one weight matrix, wherein the codebook includes a plurality of centroids; and
computing the plurality of centroids for the at least one weight matrix using K-means clustering.

18. The device of claim 17, wherein the memory includes instructions that when executed on the processor performs actions that:
generating an index matrix that maps a quantized weight of the at least one weight matrix into a centroid.

19. The device of claim 16, wherein the quantized weights are INT4 or INT8 data types.

20. The device of claim 16, wherein the deep learning model is a neural transformer model with attention.
